(19) United States
(12) Patent Application Publication
(10) Pub. No.: US 2006/0004128 A1
(43) Pub. Date: Jan. 5, 2006

(54) Stabiliser composition for halogen-containing polymers

(75) Inventors: Stefan Fokken, Biberbach (DE); Hans-Jurgen Sander, Lorsch (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Baerlocher GmbH

(21) Appl. No.: 11/139,342

(22) Filed: May 26, 2005

(30) Foreign Application Priority Data
Nov. 26, 2002 (DE) 102 55 154.5

(51) Int. Cl. C08K 5/49

(52) U.S. Cl. 524/115

(57) ABSTRACT

A stabiliser composition for foams of halogen-containing polymers, comprising from 0.01 to about 50% by weight of at least one salt of a halogen-containing oxyacid and from 0.5 to about 50% by weight of at least one blowing agent, both based on the total weight of the stabiliser composition.

### CROSS-REFERENCE TO RELATED APPLICATIONS

This is a continuation application of PCT/EP2003/013257, filed Nov. 25, 2003, which is incorporated herein by reference in its entirety, and also claims the benefit of German Priority Application No. 102 55 154.5, filed Nov. 26, 2002.

### FIELD OF THE INVENTION

The present invention relates to a stabiliser composition for foams of halogen-containing polymers. The present invention relates also to a process for the preparation of a stabiliser composition for foams of halogen-containing polymers and also to the use of a composition for stabilising a foam of halogen-containing polymers. In accordance with a further aspect, the present invention relates also to a moulded article produced from a foam of at least one halogen-containing polymer stabilised in accordance with the invention.

### BACKGROUND OF THE INVENTION

It is known that halogen-containing plastics have a tendency to undergo undesirable decomposition and breakdown reactions under thermal stress during processing or during long-term use. The breakdown of halogenated polymers, especially the breakdown of PVC, results in the formation of hydrochloric acid, which is eliminated from the polymer strand, resulting in a discoloured, unsaturated plastics having colour-imparting polyene sequences.

A particular problem in that case is that halogen-containing polymers exhibit the rheological conditions necessary for processing only at a relatively high temperature. At such temperatures, however, in the case of unstabilised polymers the polymer already begins to undergo significant decomposition, which results both in the undesirable colour change described above and in a change in the material properties. Furthermore, the hydrochloric acid freed from non-stabilised, halogen-containing polymers at such a processing temperature can lead to significant corrosion of the processing apparatus. That process plays a particular role when, during the processing of such halogenated polymers to form moulded articles, for example by extrusion, production is interrupted and the polymer mass remains in the extruder for a prolonged period. During that period the above-mentioned decomposition reactions may occur, so that the charge in the extruder is rendered unusable and the extruder may possibly be damaged.

Furthermore, polymers that are subjected to such decomposition have a tendency to adhere to the processing apparatus and the adhering portions are difficult to remove again.

In order to solve the mentioned problems, so-called stabilisers are usually added to halogen-containing polymers in the context of processing with the objective of as far as possible preventing the above-mentioned decomposition reactions. Such stabilisers are generally solids that are added to the polymers prior to processing.

In the past, however, it has often been found that in the processing of halogen-containing polymers to form foams, the use of blowing agents leads to unsatisfactory results in terms of the initial colour and the colour retention of the resulting polymer foams. Especially the use of blowing agents based on azodicarbonamide impairs the above-mentioned properties of the foams to a considerable degree.

The German patent application having the file reference DE 101 24 734.6 describes a stabiliser composition for halogen-containing polymers that comprises a salt of a halogen-containing oxy acid and an inorganic or organic acid or an inorganic base. Although the use of blowing agents is described in the context of the description, the specification makes no mention of a synergistic effect arising from the combined use of blowing agents in a certain amount together with a salt of a halogen-containing oxy acid for the production of foams of halogen-containing polymers.

DE 198 60 798 and DE 101 09 366 as well as the abstracts from STN Files CAPLUS, WPIX, JAPIO of documents JP 2001261907 A, JP 2000290418 A, JP 09165463 A, JP 09118767 A, JP 07157587 A and JP 635035635 relate to stabiliser compositions for halogen-containing polymers.

DE 100 56 880 relates to stabiliser compositions for halogen-containing organic plastics which have to comprise cyanoacetylureas and further compounds.

DE 101 09 366 A1, DE 199 15 388 A1 and DE 101 18 179 are likewise concerned with the stabilisation of halogen-containing plastics.

### SUMMARY OF THE INVENTION

The problem underlying the present invention was therefore to provide a stabiliser composition that can be used in the production of foams of halogen-containing polymers and results in an improvement in initial colour. A further problem underlying the present invention was to provide a stabiliser composition that can be used in the production of halogen-containing polymers. A further problem underlying the invention was to provide a stabiliser composition that exhibits an improvement in initial colour in the processing of foams of halogen-containing polymers in comparison with stabilisers known from the prior art.

The invention described below therefore relates firstly generally to the stabilisation of foams of halogen-containing polymers and secondly to the provision of a stabiliser composition that is already tailored to the needs of the manufacturer of such foams and, in addition to comprising a stabilising component, also already comprises a blowing agent. The term “stabiliser composition” is therefore used in the context of the following text both for compositions that are suitable for stabilising foams of halogen-containing polymers and for compositions that comprise both stabilising components and blowing agents. In the sense of the use of a stabiliser composition according to the invention, the present invention includes and relates firstly to the use of pre-mixed stabiliser compositions that comprise a blowing agent. Secondly, the invention also includes those situations in which the stabiliser composition is mixed only shortly before use in the polymer or the mixing takes place in situ in the polymer during its processing.

It has now been found that the above-mentioned problems are solved by stabiliser compositions comprising at least one salt of a halogen-containing oxy acid and at least one blowing agent component together forming more than 0.1% by weight, based on the total weight of the stabiliser composition.

The present invention accordingly relates to a stabiliser composition for foams of halogen-containing polymers, at least comprising a salt of a halogen-containing oxy acid and at least one blowing agent, the proportion of the two components together being at least 0.1% by weight, based on the total weight of the stabiliser composition.

It has also been found that a stabiliser composition comprising at least one salt of a halogen-containing oxy acid is suitable for stabilising polymer compositions that comprise at least 0.1% by weight blowing agent.

It has also been found that polymer compositions that comprise at least one halogen-containing polymer, at least one salt of a halogen-containing oxy acid and at least 0.1% by weight of a blowing agent do not exhibit the disadvantages of the blowing-agent-containing systems known from the prior art or they exhibit those disadvantages only to a very small degree.

A stabiliser composition according to the invention may be a solid stabiliser composition or a liquid stabiliser composition. When a stabiliser composition according to the invention is in the liquid state, then in the context of the present invention it preferably comprises at least one organic solvent.

### DETAILED DESCRIPTION OF THE PREFERRED EMBODIMENTS

A “stabiliser composition” is to be understood in the context of the present invention as being a composition that can be used for stabilising foams of halogen-containing polymers. For achieving that stabilising effect, a stabiliser composition according to the invention is generally mixed with a halogen-containing polymer to be stabilised and then processed. It is equally possible, however, for a stabiliser composition according to the invention to be mixed with the halogen-containing polymer to be stabilised during processing.

The term “liquid” is to be understood in the context of the present invention as being the state of aggregation of a stabiliser composition according to the invention at least within a temperature range of from about 45 to about 100° C., preferably within a temperature range of from about 30 to about 120° C., for example within a temperature range of from about 15 to about 150° C. and especially within a temperature range of from about 0 to about 200° C.

A suitable salt of a halogen-containing oxy acid is an appropriate inorganic salt or an organic salt. The expression “inorganic salt of a halogen-containing oxy acid” is to be understood in the context of this text as meaning a salt of the general formula M(ClO₄)ₖ wherein M is an inorganic cation. Possible inorganic cations M are inter alia preferably Li, Na, K, Mg, Ca, Sr, Zn, Al, La and Ce. The index k, according to the valency of M in the case of the cations that are mentioned inter alia as being preferred, is the number 1, 2 or 3.

The expression “organic salt of a halogen-containing oxy acid” is to be understood in the context of this text as meaning a salt of the general formula M(ClO₄)ₖ wherein M is a cation having at least one organic constituent. Possible organic cations M are inter alia preferably organic onium ions, the expression “organic onium ion” being understood in the context of this text as meaning ammonium, sulfonium or phosphonium ions, each carrying at least one organic radical. An onium salt in accordance with the present invention may carry 1, 2, 3 or 4 organic radicals according to the nature of the onium group. The organic radicals can be bonded to the onium radical, for example, by way of a C-X linkage, where X is S, N or P. It is equally possible, however, for the organic radicals to be bonded to the onium radical by way of a further hetero atom, for example an O atom.

An onium perchlorate suitable for use in the context of the present invention has at least one positively charged N, P or S atom or two or more such positively charged N, P or S atoms or mixtures of two or more of the mentioned, positively charged atoms.

In the context of the present invention, there are used as onium perchlorates compounds that carry at least one organic radical and at most the maximum possible number of organic radicals on the N, S or P atom. When an onium perchlorate suitable for use according to the invention carries a smaller number of organic radicals than is necessary for the formation of a positively charged onium ion, the positive charge is generated in a customary manner known to the person skilled in the art by protonation by means of a suitable acid, so that the onium perchlorate in question then carries at least one proton in addition to an organic radical.

It is therefore possible according to the invention to use as onium perchlorates compounds having a positive charge as a result of protonation reactions. It is, however, equally possible in the context of the stabiliser combinations according to the invention to use onium perchlorates having a positive charge as a result of a peralkylation reaction. Examples of such compounds are tetraalkylammonium, trialkylsulfonium and tetraalkylphosphonium perchlorates. It is, however, also provided in the context of the present invention for a peralkylated onium perchlorate suitable for use according to the invention to have an aryl, alkaryl, cycloalkyl, alkenyl, alkynyl or cycloalkenyl radical. It is likewise possible and provided according to the invention for an onium salt suitable for use in a stabiliser composition according to the invention to have two or possibly more different types of substituent, for example an alkyl radical and a cycloalkyl radical or an alkyl radical and an aryl radical.

It is likewise possible and provided in the context of the present invention for an onium salt suitable for use in a stabiliser composition according to the invention to have substituents that are themselves substituted by one or more functional groups. The term “functional groups” denotes groups that improve the activity of the stabiliser composition or at least do not impair that activity or impair it only to a negligible extent. Such functional groups can be, for example, NH groups, NH₂ groups, OH groups, SH groups, ester groups, ether groups, thioether groups, isocyanurate groups or keto groups or mixtures of two or more thereof.

Phosphonium perchlorates suitable for use in the context of the present invention are in principle any compounds that, by appropriate reaction of suitable reactants, result in a phosphonium perchlorate. Phosphonium perchlorates suitable for use according to the invention can be obtained, for example, by appropriate reaction of tetraalkyl-, tetracycloalkyl- or tetraaryl-phosphorus halideis. Suitable phosphonium perchlorates are therefore derived, for example, from tetraalkylphosphorus salts, such as tetra-n-ethylphosphonium bromide, tetra-n-propylphosphonium bromide, tetra-n-butylphosphonium bromide, tetra-n-isobutylphosphonium bromide, tetra-n-pentylphosphonium bromide, tetra-n-hexylphosphonium bromide and like tetraalkylphosphorus salts. Also suitable in principle for use in the context of the stabiliser compositions according to the invention are phosphonium perchlorates derived, for example, from tetracycloalkylphosphorus salts or tetraarylphosphorus salts. Suitable phosphonium perchlorates are therefore based, for example, on tetracycloalkyl- or tetraaryl-phosphorus salts such as tetracyclohexylphosphonium bromide or tetraphenylphosphonium bromide and like tetracycloalkyl- or tetraaryl-phosphorus salts. The compounds mentioned above can be unsubstituted in the context of the present invention, but they may also have one or more of the above-mentioned substituents provided that, in the context of the stabiliser composition, those substituents have no disadvantageous activity and have no adverse effect on the intended use of the stabiliser composition.

Also suitable for use in the context of the present invention are organic phosphonium perchlorates that carry at a phosphorus atom different types of organic substituents which in turn may optionally be differently substituted.

Within the scope of a preferred embodiment of the present invention, tetra-n-butylphosphonium perchlorate or triphenylbenzylphosphonium perchlorate is used as phosphonium perchlorate.

Sulfonium perchlorates suitable for use in the context of the present invention are in principle any compounds that, by appropriate reaction of suitable reactants, result in a sulfonium perchlorate. Sulfonium perchlorates suitable for use according to the invention can be obtained, for example, by appropriate reaction of sulfides such as alkyl monosulfides, alkyl disulfides, dialkyl sulfides or polyalkyl sulfides. Suitable sulfonium perchlorates are therefore derived, for example, from dialkyl sulfides such as ethyl benzyl sulfide, allyl benzyl sulfide or alkyl disulfides such as hexane disulfide, heptane disulfide, octane disulfide and like alkyl disulfides. Also suitable in principle for use in the context of the stabiliser compositions according to the invention are sulfonium perchlorates derived, for example, from tricycloalkylsulfonium salts or triarylsulfonium salts. Suitable sulfonium perchlorates are therefore based, for example, on tricycloalkyl- or triaryl-sulfonium salts such as tricyclohexylsulfonium bromide or triphenylsulfonium bromide and like tricycloalkyl- or triaryl-sulfonium salts. Also suitable are trialkyl-, triaryl- or tricycloalkylsulfoxonium salts such as trimethylsulfoxonium perchlorate. The compounds mentioned above can be unsubstituted in the context of the present invention, but they may also have one or more of the above-mentioned substituents provided that, in the context of the stabiliser composition, those substituents have no disadvantageous activity and have no adverse effect on the intended use of the stabiliser composition.

Also suitable for use in the context of the present invention are organic sulfonium perchlorates that carry at a sulfur atom different types of organic substituents which in turn may optionally be differently substituted.

Within the scope of a preferred embodiment of the present invention, trimethylsulfoxonium perchlorate is used as sulfonium perchlorate.

Ammonium perchlorates suitable for use in the context of the present invention are in principle any compounds that, by appropriate reaction of suitable reactants, result in an ammonium perchlorate. Ammonium perchlorates suitable for use in accordance with the invention can be obtained, for example, by appropriate reaction of amines or amides such as alkyl monoamines, alkylenediamines, alkyl polyamines, secondary or tertiary amines or dialkylamines. Suitable ammonium perchlorates are therefore derived, for example, from primary mono- or poly-amino compounds having from 2 to about 40 carbon atoms, for example from 6 to about 20 carbon atoms. Examples thereof are ethylamine, n-propylamine, isopropylamine, n-butylamine, sec-butylamine, tert-butylamine, and substituted amines having from 2 to about 20 carbon atoms, such as 2-(N,N-dimethylamino)-1-aminoethane. Suitable diamines have, for example, two primary, two secondary, two tertiary or one primary and one secondary or one primary and one tertiary or one secondary and one tertiary amino group(s). Examples thereof are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane or tertiary amines such as triethylamine, tributylamine, dimethylbenzylamine, N-ethyl-, N-methyl-, N-cyclohexyl-morpholine, dimethylcyclohexylamine, dimorpholinodiethyl ether, 1,4-diazabicyclo[2.2.2]octane, 1-azabicyclo[3.3.0]octane, N,N,N′,N′-tetramethylethylenediamine, N,N,N′,N′-tetramethylbutanediamine, N,N,N′,N′-tetramethylhexane-1,6-diamine, pentamethyldiethylenetriamine, tetramethyldiaminoethyl ether, bis(dimethylaminopropyl)urea, N,N′-dimethylpiperazine, 1,2-dimethylimidazole or di(4-N,N-dimethylaminocyclohexyl)methane.

Likewise suitable are aliphatic amino alcohols having from 2 to about 40 carbon atoms, preferably from 2 to about 20 carbon atoms, for example ethanolamine, diethanolamine, triethanolamine, tripropanolamine, tributanolamine, tripentanolamine, 1-amino-3,3-dimethyl-pentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, and aromatic-aliphatic or aromatic-cycloaliphatic amino alcohols having from 6 to about 20 carbon atoms, there being used as aromatic structures heterocyclic or isocyclic ring systems such as naphthalene derivatives or, especially, benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol and also mixtures of two or more such compounds.

Within the scope of a further embodiment of the present invention, the ammonium perchlorates used are perchlorates of heterocyclic compounds having a cyclic ring system containing amino groups. For example, there are used the perchlorates of heterocyclic amino alcohols that have at least 2, preferably at least 3, amino groups in the ring. As central ring component of the ammonium perchlorates suitable for use according to the invention there are especially suitable the trimerisation products of isocyanates.

There are suitable, for example, hydroxyl-group-containing isocyanurates of the general formula I 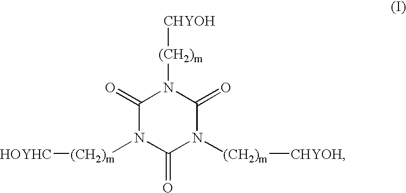
wherein the groups Y and the indices m are in each case identical or different and m is an integer from 0 to 20 and Y is a hydrogen atom or a linear or branched, saturated or unsaturated alkyl group having from 1 to about 10 carbon atoms. In the context of the present invention special preference is given to the use of tris(hydroxymethyl)isocyanurate (THEIC) as constituent of the stabiliser compositions according to the invention.

Also suitable as ammonium perchlorates are, for example, compounds in which the amino group is bonded to a substituted aromatic or heteroaromatic system, for example aminobenzoic acid, aminosalicylic acid or aminopyridinecarboxylic acid and suitable derivatives thereof.

Within the scope of a preferred embodiment of the present invention there are used as ammonium perchlorates 2-ethylcarboxypyridinium perchlorate, formamidinium perchlorate, tetra-n-butylphosphonium perchlorate, trimethylsulfoxonium perchlorate, the perchlorate salt of trishydroxyethyl isocyanurate, the perchlorate salt of 2-(diethylamino)-ethanol, N-(2-hydroxyethyl)-morpholinium perchlorate or trioctyl-ammonium perchlorate or mixtures of two or more thereof.

A stabiliser composition according to the invention in the context of the present invention may, for example, comprise only one of the above-mentioned organic onium perchlorates or only one of the above-mentioned inorganic perchlorates. In the context of the present invention it is equally possible and also provided for a stabiliser composition according to the invention to comprise a mixture of two or more of the above-mentioned perchlorates. It may be a mixture of two or more different types of organic onium perchlorates, that is to say, for example, a mixture of ammonium perchlorates and sulfonium perchlorates or ammonium perchlorates and phosphonium perchlorates or sulfonium perchlorates and phosphonium perchlorates or ammonium perchlorates and sulfonium perchlorates and phosphonium perchlorates.

It is equally possible in the context of the invention for a stabiliser composition according to the invention to comprise a mixture of two or more onium perchlorates of one type, that is to say a mixture of two or more ammonium perchlorates and a mixture of two or more sulfonium perchlorates and a mixture of two or more phosphonium perchlorates. Furthermore, it is possible in the context of the invention for a stabiliser composition according to the invention to comprise at least one inorganic perchlorate, for example at least one of the above-mentioned preferred inorganic perchlorates, together with at least one ammonium perchlorate or together with at least one sulfonium perchlorate or together with at least one phosphonium perchlorate or together with at least one ammonium perchlorate and at least one sulfonium perchlorate or together with at least one ammonium perchlorate and at least one phosphonium perchlorate or together with at least one sulfonium perchlorate and at least one phosphonium perchlorate or together with at least one ammonium perchlorate and at least one sulfonium perchlorate and at least one phosphonium perchlorate.

When a stabiliser composition according to the invention comprises a mixture of two or more onium perchlorates, those two or more onium perchlorates may be present in the stabiliser composition according to the invention in principle in any ratio.

A stabiliser composition according to the invention comprises in the context of the present invention, based on the total composition, from 0.01 to about 30% by weight, for example from about 0.1 to about 20% by weight, of an organic onium salt of a perchlorate or a mixture of two or more organic onium salts of perchlorates.

A stabiliser composition according to the invention preferably comprises as organic onium salt in the context of the present invention an ammonium or sulfonium salt or a mixture of two or more thereof, especially an ammonium salt.

In accordance with a further preferred embodiment of the stabiliser composition according to the invention, the salt of the halogen-containing oxy acid is present in very finely divided form.

The present invention therefore relates also to a stabiliser composition, as described above, which is characterised in that the composition comprises, based on the total content of the salt of a halogen-containing oxy acid, less than 10% crystallites of the salt having a crystallite size of more than 3 μm.

As very especially preferred salts of a halogen-containing oxy acid within the scope of this embodiment of the stabiliser composition according to the invention there may be mentioned salts of the general formula M(ClO₄)ₖ wherein M is Li, Na, K, Mg, Ca, Sr, Zn, Al, La, Ce or an ammonium cation of the general formula NR₄⁺, the radicals R are, each independently of the other, H or a linear or branched alkyl radical having from 1 to about 10 carbon atoms and k, according to the valency of M, is the number 1, 2 or 3. Within the scope of a very especially preferred embodiment of the present invention, a stabiliser composition according to the invention comprises in this embodiment sodium perchlorate.

The proportion of salts of a halogen-containing oxy acid or salts of a mixture of two or more halogen-containing oxy acids in the stabiliser composition according to the invention is from about 0.01 to about 50% by weight, especially from about 0.05 to about 20% by weight. Examples of contents of salts of a halogen-containing oxy acid or a mixture of two or more such salts are from about 0.1 to about 5% by weight or from about 0.2 to about 1.5% by weight.

The salts of the halogen-containing oxy acids are present in a stabiliser composition according to the invention, as described above, in especially finally divided form. Within the scope of a preferred embodiment of the present invention, less than 10% by weight of the salts of the halogen-containing oxy acid or the mixture of two or more such salts have crystallites of a size of more than 3 μm. It follows that at least about 90% by weight of the salts have crystallites of a size of less than 3 μm.

Within the scope of a further preferred embodiment of the present invention, a stabiliser composition according to the invention has a salt of a halogen-containing oxy acid or a mixture of two or more halogen-containing oxy acids, less than about 10% by weight of the salt or the salt mixture being in the form of crystallites of a size of more than 1 μm, preferably of a size of more than 500 nm. Within the scope of a further preferred embodiment of the present invention, a stabiliser composition according to the invention is substantially free of crystallites of salts of halogen-containing oxy acids having a crystallite size of more than about 250 nm. Within the scope of especially preferred embodiments of the present invention, a stabiliser composition according to the invention comprises less than about 10% by weight of the salt or salt mixture in the form of crystallites of a size of more than about 100 nm or more than about 50 nm or more than about 20 nm or more than about 10 nm or about 5 nm.

The crystallite sizes of salts of halogen-containing oxy acids, as mentioned in the context of this text, can in principle be determined by any methods of determining particle sizes. Methods that are suitable in principle include, for example, screening methods, sedimentation methods and methods based on the diffraction or refraction of electromagnetic waves, especially of light. Also suitable are electron microscopic methods, such as scanning electron microscopy or transmission electron microscopy or laser diffraction methods.

In accordance with a further embodiment, the stabiliser composition according to the invention comprises an inorganic or organic acid or an inorganic base. The inorganic or organic acids or the inorganic bases are solid compounds that are capable of forming preferably solid acid or base anhydrides. There are suitable, for example, organic acids capable of anhydride formation, for example maleic acid, phthalic acid or succinic acid.

Also suitable are, for example, inorganic acids capable of anhydride formation, for example boric acid.

Especially suitable as constituent of the stabiliser composition according to the invention, however, are inorganic bases that are capable of forming anhydrides. Suitable inorganic bases are the hydroxides of the elements of the first and second main groups of the Periodic Table and the hydroxides of the elements of the first sub-group of the Periodic Table. Magnesium hydroxide, calcium hydroxide, barium hydroxide and strontium hydroxide are especially suitable.

A stabiliser composition according to the invention may in the context of the present invention comprise, for example, only one organic or inorganic acid or one inorganic base. In the context of the present invention, however, it is likewise provided for a stabiliser composition according to the invention to comprise a mixture of two or more organic acids or two or more inorganic acids or a mixture of two or more inorganic bases or a mixture of one or more organic acids or one or more inorganic acids.

Within the scope of a preferred embodiment of the present invention, a stabiliser composition according to the invention comprises as inorganic base calcium hydroxide or magnesium hydroxide, especially calcium hydroxide.

The above-mentioned salts of halogen-containing oxy acids are already suitable as such for stabilising polymer compositions that comprise at least 0.1% by weight of a blowing agent or a mixture of two or more blowing agents. The present invention therefore relates also to the use of a salt of a halogen-containing oxy acid or a mixture of two or more such salts in a composition for stabilising a polymer composition that comprises at least one halogen-containing polymer and at least 0.1% by weight of a blowing agent, the composition comprising, based on the total content of the salt of a halogen-containing oxy acid, less than 10% crystallites of the salt having a crystallite size of more than 3 μm.

As further constituent, a stabiliser composition according to the invention comprises at least one blowing agent. As blowing agents there may be used in principle any suitable compounds. Suitable blowing agents are, for example, organic azo and hydrazo compounds, tetrazoles, oxazines, isatoic anhydride, salts of citric acid, for example ammonium citrate, and also sodium carbonate and sodium hydrogen carbonate. Especially suitable, for example, are ammonium citrate, azodicarbonamide and sodium hydrogen carbonate or mixtures of two or more thereof. Azodicarbonamide is very especially suitable and preferred as blowing agent in the context of the present invention.

The present invention accordingly relates also to a stabiliser composition, as described above, which is characterised in that the blowing agent is azodicarbonamide.

In the context of this text, the individual blowing agents also include preparations that comprise the blowing agent(s) in question. Such preparations may comprise, for example, in addition to the blowing agents, compounds that have been added to the blowing agents to increase stability, for example in respect of transport or/and storage stability.

In accordance with a further preferred embodiment, the stabiliser composition according to the invention comprises the at least one blowing agent in an amount of from 0.5 to 30% by weight.

The present invention therefore relates also to a stabiliser composition, as described above, which is characterised in that the composition comprises the at least one blowing agent in an amount in the range of from 0.5 to 50% by weight, for example from about 1 to about 30% by weight or from about 2.5 to about 20% by weight, based on the total weight of the stabiliser composition.

A stabiliser composition according to the invention can in the context of the present invention be in solid or liquid state. According to the state of aggregation, the composition according to the invention may comprise, for example, one or more of the solvents listed below or one or more of the following additives.

Suitable as additives in the context of the present invention are, for example, aminouracil compounds of the general formula II 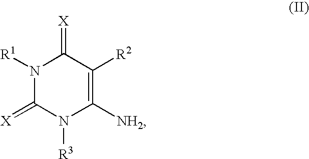
wherein the radicals R¹ and R² are, each independently of the other, hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, or an unsubstituted or substituted aryl radical having from 6 to 44 carbon atoms or an unsubstituted or substituted aralkyl radical having from 7 to 44 carbon atoms, or the radical R¹ is an unsubstituted or substituted acyl radical having from 2 to 44 carbon atoms or the radicals R¹ and R² are linked to form an aromatic or heterocyclic system and wherein the radical R³ is hydrogen, an unsubstituted or substituted linear or branched, saturated or unsaturated aliphatic hydrocarbon radical having from 1 to 44 carbon atoms, an unsubstituted or substituted saturated or unsaturated cycloaliphatic hydrocarbon radical having from 6 to 44 carbon atoms or an unsubstituted or substituted aromatic hydrocarbon radical having from 6 to 44 carbon atoms and wherein X is S or O.

Within the scope of a further preferred embodiment of the present invention, in the stabiliser compositions according to the invention there are used compounds of the general formula II wherein R¹ and R³ are a linear or branched alkyl radical having from 1 to 6 carbon atoms, for example methyl, ethyl, propyl, butyl, pentyl or hexyl, an OH— group-substituted linear or branched alkyl radical having from 1 to 6 carbon atoms, for example hydroxymethyl, hydroxyethyl, hydroxypropyl, hydroxybutyl, hydroxypentyl or hydroxyhexyl, an aralkyl radical having from 7 to 9 carbon atoms, for example benzyl, phenylethyl, phenylpropyl, dimethylbenzyl or phenylisopropyl, it being possible for the mentioned aralkyl radicals to be substituted, for example, by halogen, hydroxy or methoxy, or an alkenyl radical having from 3 to 6 carbon atoms, for example vinyl, alkyl, methallyl, 1-butenyl or 1-hexenyl.

Within the scope of a preferred embodiment of the present invention, in the stabiliser compositions according to the invention there are used compounds of the general formula III wherein R¹ and R³ are hydrogen, methyl, ethyl, n-propyl, isopropyl, n-, iso-, sec- or tert-butyl.

Also suitable as additives are, for example, generally compounds having a structural element of the general formula III 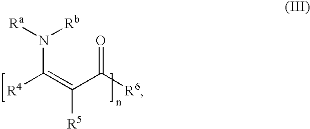
wherein n is a number from 1 to 100,000, the radicals R^{a}, R^{b}, R⁴ and R⁵ are, each independently of the others, hydrogen, an unsubstituted or substituted linear or branched, saturated or unsaturated aliphatic alkyl radical having from 1 to 44 carbon atoms, an unsubstituted or substituted saturated or unsaturated cycloalkyl radical having from 6 to 44 carbon atoms, or an unsubstituted or substituted aryl radical having from 6 to 44 carbon atoms or an unsubstituted or substituted aralkyl radical having from 7 to 44 carbon atoms, or the radical R⁴ is an unsubstituted or substituted acyl radical having from 2 to 44 carbon atoms or the radicals R⁴ and R⁵ are linked to form an aromatic or heterocyclic system and wherein the radical R⁶ is hydrogen, an unsubstituted or substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having from 1 to 44 carbon atoms, an unsubstituted or substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having from 6 to 44 carbon atoms or an unsubstituted or substituted aryl or arylene radical having from 6 to 44 carbon atoms or an ether or thioether radical having from 1 to 20 O or S atoms or O and S atoms, or is a polymer that is bonded to the structural element in brackets by way of O, S, NH, NR^{a} or CH₂C(O), or the radical R⁶ is so linked to the radical R⁴ that in total an unsubstituted or substituted, saturated or unsaturated heterocyclic ring system having from 4 to 24 carbon atoms is formed.

Within the scope of a preferred embodiment of the present invention, as the compound of the general formula III there is used a compound based on an α,β-unsaturated β-aminocarboxylic acid, especially a compound based on β-aminocrotonic acid. Especially suitable are the esters or thioesters of corresponding aminocarboxylic acids with monovalent or polyvalent alcohols or mercaptans.

The present invention therefore relates also to a stabiliser composition, as described above, which is characterised in that the composition comprises at least one compound based on an α,β-unsaturated β-aminocarboxylic acid.

When the radical R⁶ is an alcohol or mercaptan radical, such a radical can be formed, for example, from methanol, ethanol, propanol, isopropanol, butanol, 2-ethylhexanol, isooctanol, isononanol, decanol, lauryl alcohol, myristyl alcohol, palmityl alcohol, stearyl alcohol, ethylene glycol, propylene glycol, butylene glycol, 1,3-butanediol, 1,4-butanediol, 1,6-hexanediol, 1,10-decanediol, diethylene glycol, thio-diethanol, trimethylolpropane, glycerol, tris(2-hydroxymethyl) isocyanurate, triethanolamine, pentaerythritol, di-trimethylolpropane, diglycerol, sorbitol, mannitol, xylitol, di-pentaerythritol and also the corresponding mercapto derivatives of the mentioned alcohols.

Within the scope of an especially preferred embodiment of the present invention, as the compound of the general formula III there is used a compound in which R⁴ is a linear alkyl radical having from 1 to 4 carbon atoms, R⁵ is hydrogen and R⁶ is a linear or branched, saturated, mono- to hexa-valent alkyl or alkylene radical having from 2 to 12 carbon atoms or a linear, branched or cyclic 2- to 6-valent ether alcohol radical or thioether alcohol radical.

Suitable compounds of the general formula III include, for example, β-amino-crotonic acid stearyl ester, 1,4-butanediol di(β-aminocrotonic acid) ester, thio-diethanol-β-aminocrotonic acid ester, trimethylolpropane tri-β-aminocrotonic acid ester, penta-erythritol-tetra-α-aminocrotonic acid ester, dipentaerythritol-hexa-β-aminocrotonic acid ester and the like. The mentioned compounds can be present in a stabiliser composition according to the invention singly or as a mixture of two or more thereof.

Also suitable as compounds of the general formula III are, for example, compounds in which the radicals R⁴ and R⁵ are linked to form an aromatic or heteroaromatic system, for example aminobenzoic acid, aminosalicylic acid or aminopyridinecarboxylic acid and suitable derivatives thereof.

Within the scope of a preferred embodiment of the present invention, a stabiliser composition according to the invention comprises a compound of the general formula III in an amount of from about 0.1 to about 99.5% by weight, especially from about 5 to about 50% by weight or from about 5 to about 25% by weight.

Also suitable as additives to the stabiliser composition according to the invention are metal oxides, metal hydroxides and metal soaps of saturated, unsaturated, straight-chain or branched, aromatic, cycloaliphatic or aliphatic carboxylic acids or hydroxycarboxylic acids having especially from about 2 to about 22 carbon atoms.

As metal cations, the metal oxides, metal hydroxides or metal soaps suitable as additives have especially a divalent cation; the cations of calcium or zinc or lead or mixtures of two or more thereof are especially suitable.

Examples of suitable carboxylic acid anions include anions of monovalent carboxylic acids, such as acetic acid, propionic acid, butyric acid, valeric acid, hexanoic acid, oenanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, toluic acid, dimethylbenzoic acid, ethylbenzoic acid, n-propylbenzoic acid, salicylic acid, p-tert-octylsalicylic acid, sorbic acid, anions of divalent carboxylic acids or monoesters thereof, such as oxalic acid, malonic acid, maleic acid, tartaric acid, cinnamic acid, mandelic acid, malic acid, glycolic acid, oxalic acid, salicylic acid, polyglycoldicarboxylic acids having a degree of polymerisation of from approximately 10 to approximately 12, phthalic acid, isophthalic acid, terephthalic acid or hydroxyphthalic acid, anions of tri- or tetra-valent carboxylic acids or mono-, di- or tri-esters thereof, as in hemimellitic acid, trimellitic acid, pyromellitic acid or citric acid, and also so-called overbased carboxylates as described, for example, in DE-A 41 06 404 or DE-A 40 02 988, the disclosure of the last-mentioned documents being regarded as part of the disclosure of this text.

Within the scope of a further embodiment of the present invention there are used as additives metal soaps having anions derived from saturated or unsaturated carboxylic acids or hydroxycarboxylic acids having from about 8 to about 20 carbon atoms. Special preference is given to stearates, oleates, laurates, palmitates, behenates, versatates, hydroxystearates, dihydroxystearates, p-tert-butyl benzoates or (iso)octanoates of calcium or zinc or mixtures of two or more thereof. Within the scope of a further embodiment of the present invention, a stabiliser composition according to the invention has calcium stearate or zinc stearate or a mixture thereof.

A stabiliser composition according to the invention can comprise the mentioned metal oxides, metal hydroxides or metal soaps, or a mixture of two or more thereof, in an amount of up to about 50% by weight, for example in an amount of up to about 30% by weight.

Within the scope of an especially preferred embodiment of the present invention, the stabiliser compositions according to the invention are, however, free of zinc and especially free of lead or cadmium.

The present application therefore relates also to a stabiliser composition, as described above, which is characterised in that the composition is substantially free of zinc, lead or cadmium.

A stabiliser composition according to the invention can comprise at least one organic solvent. This is especially preferably the case, for example, because the stabiliser composition according to the invention is in liquid state.

A “solvent” is to be understood in the context of the present invention as being a compound or a mixture of two or more compounds that is liquid within a certain temperature range and that is capable of dissolving the at least one halogen-containing salt of an oxy acid used in the context of the stabiliser composition according to the present invention in an amount of at least 0.1% by weight, based on the total weight of the at least one undissolved halogen-containing salt of the oxy acid. A suitable solvent in the context of the present invention is liquid at least within a temperature range of from about 45 to about 100° C., preferably within a temperature range of from about 30 to about 120° C., for example within a temperature range of from about 15 to about 150° C. and especially within a temperature range of from about 0 to about 200° C.

Within the scope of a preferred embodiment of the present invention, there are used as solvents compounds or mixtures of two or more compounds that are suitable as plasticisers for halogen-containing polymers.

Suitable solvents in the sense of this text are therefore, for example, compounds from the group of phthalic acid esters, such as dimethyl, diethyl, dibutyl, dihexyl, di-2-ethylhexyl, di-n-octyl, diisooctyl, diisononyl, diisodecyl, dicyclohexyl, dimethylcyclohexyl, dimethyl glycol, dibutyl glycol, benzylbutyl or diphenyl phthalate and also mixtures of phthalates, for example mixtures of alkyl phthalates having from 7 to 9 or 9 to 11 carbon atoms in the ester alcohol or mixtures of alkyl phthalates having from 6 to 10 and 8 to 10 carbon atoms in the ester alcohol. Especially suitable in the sense of the present invention are dibutyl, dihexyl, di-2-ethylhexyl, di-n-octyl, diisooctyl, diisononyl, diisodecyl, diisotridecyl and benzylbutyl phthalate and also the mentioned mixtures of alkyl phthalates.

Also suitable as solvents are the esters of aliphatic dicarboxylic acids, especially the esters of adipic, azelaic or sebacic acid or mixtures of two or more thereof. Examples of such solvents are di-2-ethylhexyl adipate, diisooctyl adipate, diisononyl adipate, diisodecyl adipate, benzylbutyl adipate, benzyloctyl adipate, di-2-ethylhexyl azelate, di-2-ethylhexyl sebacate and diisodecyl sebacate. Within the scope of a further embodiment of the present invention preference is given to di-2-ethylhexyl acetate and diisooctyl adipate.

Also suitable as solvents are trimellitic acid esters, such as tri-2-ethylhexyl trimellitate, triisotridecyl trimellitate, triisooctyl trimellitate and also trimellitic acid esters having from 6 to 8, 6 to 10, 7 to 9 or 9 to 11 carbon atoms in the ester group or mixtures of two or more of the mentioned compounds.

Further suitable solvents are, for example, polymer plasticisers, as mentioned in “Kunststoffadditive”, R. Gächter/H. Müller, Carl Hanser Verlag, 3rd edition, 1989, chapter 5.9.6, pages 342-489, or “PVC Technology”, W. V. Titow, 4th Edition, Elsevier Publishers, 1984, pages 165-170. Reference is expressly made herewith to the mentioned specifications, and the plasticisers that are mentioned in the context of the first-mentioned reference (R. Gätchter/H. Müller) and are suitable as solvents in the sense of the invention, especially the compounds mentioned in Tables 9a (pp. 388-392), 10 (p. 396), 11 (p. 400), 12a (pp. 402-404), 13a (pp. 408-410), 13b (p. 412), 14 (p. 413), 16 (p. 418), 3 (p. 479) and 4 (pp. 486-488), are to regarded as part of the disclosure of this text.

The starting materials most commonly used for the preparation of polyester plasticisers are, for example, dicarboxylic acids, such as adipic, phthalic, azelaic or sebacic acid, and diols, such as 1,2-propanediol, 1,3-butanediol, 1,4-butanediol, 1,6-hexanediol, neopentyl glycol or diethylene glycol or mixtures of two or more thereof.

Also suitable as plasticisers are phosphoric acid esters, such as those in “Taschenbuch der Kunststoffadditive”, chapter 5.9.5, pages 408-412. Examples of suitable phosphoric acid esters are tributyl phosphate, tri-2-ethylbutyl phosphate, tri-2-ethylhexyl phosphate, trichloroethyl phosphate, 2-ethyl-hexyl-di-phenyl phosphate, triphenyl phosphate, tricresyl phosphate and trixylenyl phosphate, or mixtures of two or more thereof.

The compounds listed below are especially suitable as solvents in the context of the present invention: 2-hydroxy-5-methyl-benzoic acid methyl ester, 2-ethoxybenzyl alcohol, N-ethyl-2,3-dimethylaniline, 2-hydroxy-3-methyl-benzoic acid methyl ester, lauric acid benzyl ester, 3,4,5-trimethoxybenzyl alcohol, 3,5-dimethylbenzyl alcohol, 3-methylbenzophenone, 2-methoxyacetophenone, 3-cyclohexylpropionic acid, cyclopentanecarboxylic acid, 2,5-dimethylbenzonitrile, 4-(4-methoxyphenyl)-butan-2-one, formic acid cinnamyl ester, triethyl citrate, decanedioic acid dibutyl ester, heptaethylene glycol decanedioic acid diethyl ester, adipic acid dibutyl ester, 1,2-bis(2-acetoxy-ethoxy)-ethane, azelaic acid diethyl ester, suberic acid diethyl ester, glutaric acid diethyl ester, myristic acid ethyl ester, oxalic acid dibutyl ester, 9-decenyl propionate, lauric acid methyl ester, acetic acid decyl ester, cyanoacetic acid butyl ester, hexanoic acid pentyl ester, acetic acid nonyl ester, decanoic acid methyl ester, nonanoic acid methyl ester, undecylene alcohol, N-methyldioctylamine, diethylene glycol dibutyl ether, dioctyl ether, decan-3-one, 4-oxa-heptanedinitrile, nonanenitrile, diethylene glycol monohexyl ether, diisobutyl ketone, formic acid butyl ester, n-tridecyl alcohol, butyl carbitol, glutaric acid dinitrile, propionic acid methyl ester, thioformic acid dimethylamide, octamethylenedimercaptan, 2-ethylhexane-1,3-diol, decan-4-ol, decane-1-thiol, hexamethylenedimercaptan, trimethylene iodide, dodecan-2-ol, N-butylformamide, diisopentyl sulfide, hexaethylene glycol, pentaethylene glycol, trioctylamine, dipropylenetriamine, triethylene glycol, dodecylmercaptan, 2,2′-dithiodiglycol, diethyl carbonate, m-tolyl isothiocyanate, linolenic acid, triethylenetetramine, 5H-furan-2-one, 4-benzylpiperidine, 1-phenylpiperidine, isonicotinic acid ethyl ester, pyridine-2-carboxylic acid ethyl ester, 2,3,3-trimethyl-3H-indole, 3-methylsulfolan, propylene carbonate, 3-piperidinopropionitrile, sulfolan, tetrahydrothiophene-1-oxide, 4-morpholinoethanol and 4-octylaniline.

The above-mentioned solvents can be present in a stabiliser composition according to the invention singly or in the form of a mixture of two or more thereof.

When a stabiliser composition according to the invention is a liquid stabiliser composition comprising two or more of the above-mentioned compounds as solvents, one or more of the compounds may fall outside the above definition of the term “liquid” provided that the total solvent mixture falls within that definition.

A stabiliser composition according to the invention comprises a solvent or solvent mixture in an amount of from less than about 99.9 to about 2% by weight, for example from about 98 to about 3% by weight or from about 95 to about 5% by weight. The content of solvents can vary within a wide range, depending upon whether the stabiliser composition according to the invention is being used as the sole stabiliser or together with one or more additives or is to be in a solid or liquid state. For example, a liquid stabiliser composition according to the invention may have, for example, a solvent content of from about 20 to about 99.9% by weight or from about 99 to about 30% by weight or from about 95 to about 35% by weight or from about 90 to about 40% by weight or from about 85 to about 50% by weight. In the case of a solid stabiliser composition according to the invention, the solvent content can be, for example, from about 50 to about 0.01% by weight or from about 45 to about 0.1% by weight or from about 40 to about 1% by weight or from about 35 to about 3% by weight or from about 30 to about 5% by weight.

In addition to comprising the at least one salt of a halogen-containing oxy acid, the at least one blowing agent and the additives already described above, such as, for example, the at least one solvent, a stabiliser composition according to the invention may also comprise one or more further additives in an amount of up to about 95% by weight, for example up to about 93% by weight or about 91% by weight or from about 0 to about 90% by weight or from about 1 to about 85% by weight.

Also suitable as additives are, for example, amino alcohols. Suitable amino alcohols in the context of the present invention are in principle any compounds having at least one OH group and a primary, secondary or tertiary amino group or a combination of two or more of the mentioned amino groups. In principle, in the context of the present invention both solid and liquid amino alcohols are suitable as a constituent of the stabiliser compositions according to the invention. If, however, in the context of the present invention the stabiliser composition should be, for example, in solid form, the proportion of liquid amino alcohols is, for example, so chosen that the entire stabiliser composition is substantially in solid form.

Within the scope of a further preferred embodiment of the present invention, a stabiliser composition according to the invention comprises a maximum of about 5% by weight liquid amino alcohol or a mixture of two or more liquid amino alcohols, but the proportion is preferably lower, for example 1% by weight or less. Within the scope of an especially preferred embodiment of the present invention, a stabiliser composition according to the invention does not contain any liquid amino alcohols.

Amino alcohols suitable for use in the context of the present invention have, within the scope of a preferred embodiment of the present invention, a melting point higher than about 30° C., especially higher than about 50° C. Suitable amino alcohols are, for example, mono- or poly-hydroxy compounds which are based on linear or branched, saturated or unsaturated aliphatic mono- or poly-amines.

There are suitable in this connection, for example, OH-group-carrying derivatives of primary mono- or poly-amino compounds having from 2 up to about 40, for example from 6 up to about 20, carbon atoms. Examples thereof are corresponding OH-group-carrying derivatives of ethylamine, n-propylamine, isopropylamine, sec-propylamine, tert-butylamine, 1-aminoisobutane, and substituted amines having from 2 to about 20 carbon atoms, such as 2-(N,N-dimethylamino)-1-aminoethane. Suitable OH-group-carrying derivatives of diamines are, for example, those based on diamines having a molecular weight of from about 32 to about 200 g/mol, the corresponding diamines having at least two primary, two secondary, or one primary and one secondary amino group(s). Examples thereof are diaminoethane, the isomeric diaminopropanes, the isomeric diaminobutanes, the isomeric diaminohexanes, piperazine, 2,5-dimethyl-piperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines, such as diethylenetriamine or 1,8-diamino-4-aminomethyloctane, triethylamine, tributylamine, dimethylbenzylamine, N-ethyl-, N-methyl-, N-cyclohexyl-morpholine, dimethylcyclohexylamine, dimorpholinodiethyl ether, 1,4-diazabicyclo[2.2.2]octane, 1-azabicyclo[3.3.0]octane, N,N,N′,N′-tetramethylethylenediamine, N,N,N′,N′-tetramethylbutanediamine, N,N,N′,N′-tetramethyl-1,6-hexanediamine, pentamethyldiethylenetriamine, tetramethyldiaminoethyl ether, bis(dimethylamino-propyl)urea, N,N′-dimethylpiperazine, 1,2-dimethylimidazole and di(4-N,N-dimethyl-aminocyclohexyl)methane.

Especially suitable are aliphatic amino alcohols having from 2 to about 40, preferably from 6 to about 20, carbon atoms, for example 1-amino-3,3-dimethyl-pentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, aromatic-aliphatic or aromatic-cycloaliphatic amino alcohols having from 6 to about 20 carbon atoms, there coming into consideration as aromatic structures heterocyclic or isocyclic ring systems such as naphthalene derivatives or, especially, benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and also mixtures of two or more such compounds.

Within the scope of an especially preferred embodiment of the present invention, the amino alcohols used are heterocyclic compounds having a cyclic ring system containing amino groups, the OH groups being bonded to the ring either directly or preferably by way of spacers.

Within the scope of an especially preferred embodiment of the present invention there are used heterocyclic amino alcohols that have at least 2, preferably at least 3 amino groups in the ring. As central ring component of the amino alcohols suitable for use according to the invention there are especially suitable the trimerisation products of isocyanates.

Special preference is given to hydroxyl-group-containing isocyanurates of the general formula I already described above 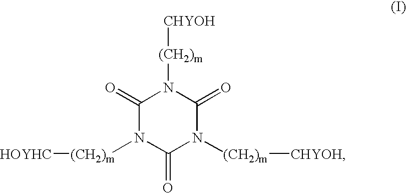
wherein the groups Y and the indices m are in each case identical or different and m is an integer from 0 to 20 and Y is a hydrogen atom or a linear or branched, saturated or unsaturated alkyl group having from 1 to about 10 carbon atoms. In the context of the present invention special preference is given to the use of tris(hydroxy-methyl)isocyanurate (THEIC) as constituent of the stabiliser compositions according to the invention.

A stabiliser composition according to the invention may, for example, comprise only one amino alcohol. In the context of the present invention, however, a stabiliser composition according to the invention may equally comprise a mixture of two or more different amino alcohols.

Further suitable additives are, for example, compounds that have a mercapto-functional sp²-hybridised carbon atom, carbazoles, carbazole derivatives or 2,4-pyrrolidinedione or 2,4-pyrrolidinedione derivatives.

Compounds having at least one mercapto-functional sp²-hybridised carbon atom are to be understood in the context of the present invention as being in principle any compounds having a structural element Z=CZ-SH or a structural element Z₂C═S, it being possible for the two structural elements to be tautomeric forms of a single compound. The sp²-hybridised carbon atom may be a constituent of an unsubstituted or substituted aliphatic compound or a constituent of an aromatic system. Suitable types of compound are, for example, thiocarbamic acid derivatives, thiocarbamates, thiocarboxylic acids, thiobenzoic acid derivatives, thioacetone derivatives or thiourea or thiourea derivatives. Z denotes atoms or structural elements suitable for participating in a corresponding tautomeric, for example N or C.

Within the scope of a preferred embodiment of the present invention, thiourea or a thiourea derivative is used as the additive having at least one mercapto-functional, Sp2-hybridised carbon atom.

Likewise suitable as additives for the stabiliser compositions according to the invention are, for example, carbazole or carbazole derivatives or mixtures of two or more thereof.

Further suitable additives are, for example, 2,4-pyrrolidinedione and derivatives thereof, such as are mentioned, for example, in the non-prior-published German patent application having the file reference 101 09 366.7.

Also suitable as additives are, for example, epoxy compounds. Examples of such epoxy compounds are epoxidised soybean oil, epoxidised olive oil, epoxidised linseed oil, epoxidised castor oil, epoxidised groundnut oil, epoxidised maize oil, epoxidised cottonseed oil, and also glycidyl compounds.

Glycidyl compounds contain a glycidyl group that is bonded directly to a carbon, oxygen, nitrogen or sulfur atom. Glycidyl or methylglycidyl esters are obtainable by reaction of a compound having at least one carboxyl group in the molecule and epichlorohydrin or glycerol dichlorohydrin or methyl-epichlorohydrin. The reaction is advantageously carried out in the presence of bases.

As compounds having at least one carboxyl group in the molecule there can be used, for example, aliphatic carboxylic acids. Examples of such carboxylic acids are glutaric acid, adipic acid, pimelic acid, suberic acid, azelaic acid, sebacic acid or dimerised or trimerised linoleic acid, acrylic acid, methacrylic acid, caproic acid, caprylic acid, lauric acid, myristic acid, palmitic acid, stearic acid or pelargonic acid and also the mono- or poly-carboxylic acids mentioned hereinbelow. Also suitable are cycloaliphatic carboxylic acids, such as cyclohexanecarboxylic acid, tetrahydrophthalic acid, 4-methyltetrahydrophthalic acid, hexahydrophthalic acid, endomethylene-tetrahydrophthalic acid or 4-methylhexahydrophthalic acid. Also suitable are aromatic carboxylic acids, such as benzoic acid, phthalic acid, isophthalic acid, trimellitic acid and pyromellitic acid.

Glycidyl ethers or methylglycidyl ethers can be obtained by reaction of a compound having at least one free alcoholic OH group or a phenolic OH group and a suitably substituted epichlorohydrin under alkaline conditions or in the presence of an acidic catalyst and subsequent alkali treatment. Ethers of this type are derived, for example, from acyclic alcohols, such as ethylene glycol, diethylene glycol or higher poly(oxyethylene) glycols, propane-1,2-diol or poly(oxypropylene) glycols, butane-1,4-diol, poly(oxytetramethylene) glycols, pentane-1,5-diol, hexane-1,6-diol, hexane-2,4,6-triol, glycerol, 1,1,1-trimethylolpropane, bis-trimethylolpropane, pentaerythritol, sorbitol, and also from polyepichlorohydrins, butanol, amyl alcohol, pentanol, and also from monofunctional alcohols, such as isooctanol, 2-ethylhexanol, isodecanol or technical alcohol mixtures, for example technical fatty alcohol mixtures.

Suitable ethers are also derived from cycloaliphatic alcohols, such as 1,3- or 1,4-dihydroxycyclohexane, bis(4-hydroxycyclohexyl)methane, 2,2-bis(4-hydroxycyclohexyl)-propane or 1,1-bis(hydroxymethyl)cyclohexan-3-ene, or they have aromatic nuclei, such as N,N-bis(2-hydroxyethyl)aniline. Suitable epoxy compounds can also be derived from mononuclear phenols, for example from phenol, resorcinol or hydroquinone, or they are based on polynuclear phenols, such as bis(4-hydroxyphenyl)methane, 2,2-bis(4-hydroxyphenyl)propane, 2,2-bis(3,5-dibromo-4-hydroxyphenyl)propane, 4,4′-dihydroxydiphenylsulfones, or on condensation products of phenol with formaldehyde, for example phenol novolaks, obtained under acidic conditions.

Further terminal epoxides suitable as additives in the context of the present invention are, for example, glycidyl-1-naphthyl ether, glycidyl-2-phenyl phenyl ether, 2-diphenylglycidyl ether, N-(2,3-epoxypropyl)phthalimide and 2,3-epoxypropyl-4-methoxyphenyl ether.

Also suitable are N-glycidyl compounds, such as are obtainable by dehydro-chlorination of the reaction products of epichlorohydrin with amines containing at least one amino hydrogen atom. Such amines are, for example, aniline, N-methylaniline, toluidine, n-butylamine, bis(4-aminophenyl)methane, m-xylylenediamine and bis(4-methylaminophenyl)methane.

Likewise suitable are S-glycidyl compounds, for example di-S-glycidyl ether derivatives, that are derived from dithiols, such as ethane-1,2-dithiol or bis(4-mercapto-methylphenyl) ether.

Especially suitable epoxy compounds are described, for example, on pages 3 to 5 of EP-A 1 046 668, reference being expressly made to the disclosure contained therein, which is to be regarded as part of the disclosure of this text.

Also suitable as additives in the context of the present invention are 1,3-dicarbonyl compounds, especially the β-diketones and β-keto esters. Suitable in the context of the present invention are dicarbonyl compounds of the general formula R′C(O)CHR″—C(O)R′″, as described, for example, on page 5 of EP 1 046 668, to which reference is expressly made especially in respect of the radicals R′, R″ and R′″ and the disclosure of which is regarded as being part of the disclosure of this text. Especially suitable are, for example, acetylacetone, butanoyl acetone, heptanoyl acetone, stearoyl acetone, palmitoyl acetone, lauroyl acetone, 7-tert-nonylthioheptanedione-2,4, benzoyl acetone, dibenzoylmethane, lauroylbenzoylmethane, palmitoylbenzoylmethane, stearoylbenzoylmethane, isooctylbenzoylmethane, 5-hydroxycapronylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, benzoylformylmethane, benzoylacetylphenylmethane, 1-benzoyl-1-acetyinonane, stearoyl-4-methoxybenzoylmethane, bis(4-tert-butylbenzoyl)-methane, benzoylphenylacetylmethane, bis(cyclohexanoyl)methane, dipivaloylmethane, 2-acetylcyclopentanone, 2-benzoylcyclopentanone, diacetoacetic acid methyl, ethyl, butyl, 2-ethylhexyl, dodecyl or octadecyl ester and also propionyl or butyryl acetic acid esters having from 1 to 18 carbon atoms, and also stearoyl acetic acid ethyl, propyl, butyl, hexyl or octyl esters or polynuclear β-keto esters, as described in EP-A 433 230, to which reference is expressly made, or dehydracetic acid and also the zinc, magnesium or alkali salts thereof or the alkali, alkaline earth or zinc chelates of the mentioned compounds insofar as they exist and are miscible with the stabiliser compositions according to the invention to achieve the above-mentioned results.

1,3-Diketo compounds can be present in a stabiliser composition according to the invention in an amount of up to about 20% by weight, for example up to about 10% by weight.

Polyols are also suitable as additives in the context of the stabiliser composition according to the invention. Suitable polyols are, for example, pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, lycasine, mannitol, lactose, leucrose, tris(hydroxymethyl) isocyanurate, palatinite, tetramethylolcyclohexanol, tetramethylolcyclopentanol, tetramethylolcycloheptanol, glycerol, diglycerol, polyglycerol, thiodiglycerol or 1-0-α-D-glycopyranosyl-D-mannitol dihydrate.

The polyols suitable as additives can be present in a stabiliser composition according to the invention in an amount of up to about 30% by weight, for example up to about 10% by weight.

Also suitable as additives are, for example, sterically hindered amines, such as those mentioned on pages 7 to 27 of EP-A 1 046 668. Reference is expressly made to the sterically hindered amines disclosed therein, the compounds mentioned therein being regarded as part of the disclosure of this text.

The sterically hindered amines suitable as additives can be present in a stabiliser composition according to the invention in an amount of up to about 30% by weight, for example up to about 10% by weight.

A stabiliser composition according to the invention can furthermore comprise as additive an organotin compound or a mixture of two or more organotin compounds. Suitable organotin compounds are, for example, methyltin-tris(isooctyl-thioglycolate), methyltin-tris(isooctyl-3-mercaptopropionate), methyltin-tris(isodecyl-thioglycolate), dimethyltin-bis(isooctyl-thioglycolate), dibutyltin-bis(isooctyl-thioglycolate), monobutyltin-tris(isooctyl-thioglycolate), dioctyltin-bis(isooctyl-thioglycolate), monooctyltin-tris(isooctyl-thioglycolate) or dimethyltin-bis(2-ethylhexyl-β-mercaptopropionate).

Furthermore, in the context of the stabiliser compositions according to the invention it is possible to use the organotin compounds which are mentioned and the preparation of which is described on pages 18 to 29 of EP-A 0 742 259. Reference is expressly made to the above-mentioned disclosure, the compounds mentioned therein and their preparation being understood as being part of the disclosure of this text.

A stabiliser composition according to the invention can comprise the described organotin compounds in an amount of up to about 40% by weight, especially up to about 20% by weight.

Within the scope of a further embodiment of the present invention, a stabiliser composition according to the invention can comprise organic phosphite esters having from 1 to 3 organic radicals, two or more of which radicals may be identical or all of which may be different. Suitable organic radicals are, for example, linear or branched, saturated or unsaturated alkyl radicals having from 1 to 24 carbon atoms, unsubstituted or substituted alkyl radicals having from 6 to 20 carbon atoms or unsubstituted or substituted aralkyl radicals having from 7 to 20 carbon atoms. Examples of suitable organic phosphite esters are tris(nonylphenyl), trilauryl, tributyl, trioctyl, tridecyl, tridodecyl, triphenyl, octyidiphenyl, dioctylphenyl, tri(octylphenyl), tribenzyl, butyldicresyl, octyl-di(octylphenyl), tris(2-ethylhexyl), tritolyl, tris(2-cyclohexylphenyl), tri-α-naphthyl, tris(phenylphenyl), tris(2-phenylethyl), tris(dimethylphenyl), tricresyl or tris(p-nonylphenyl) phosphite or tristearyl sorbitol-triphosphite or mixtures of two or more thereof.

A stabiliser composition according to the invention can comprise the described phosphite compounds in an amount of up to about 30% by weight, especially up to about 10% by weight.

A stabiliser composition according to the invention can also comprise as additives blocked mercaptans, as mentioned on pages 4 to 18 of EP-A 0 742 259. Reference is expressly made to the disclosure in the specification indicated, which is understood as being part of the disclosure of this text. A stabiliser composition according to the invention can comprise the described blocked mercaptans in an amount of up to about 30% by weight, especially up to about 10% by weight.

A stabiliser composition according to the invention can also comprise lubricants, such as montan wax, fatty acid esters, purified or hydrogenated natural or synthetic triglycerides or partial esters, polyethylene waxes, amide waxes, chloroparaffins, glycerol esters or alkaline earth soaps unless those lubricants fall under the term “solvents” in the sense of this text. Lubricants suitable for use as additives are also described in “Kunststoffadditive”, R. Gächter/H. Müller, Carl Hanser Verlag, 3rd edition, 1989, pages 478-488. Also suitable as additives are, for example, fatty ketones, as described in DE 4,204,887, and also silicone-based lubricants, as mentioned, for example, in EP-A 0 259 783, or combinations thereof, as mentioned in EP-A 0 259 783. Reference is expressly made to the mentioned documents, the disclosure of which relating to lubricants is to be regarded as being part of the disclosure of this text. A stabiliser composition according to the invention can comprise the described lubricants in an amount of up to about 70% by weight, especially up to about 40% by weight.

Also suitable as additives for stabiliser compositions according to the present invention are organic plasticisers unless such plasticisers already fall under the term “solvents” in the sense of this text. A stabiliser composition according to the invention can comprise the described plasticisers in an amount of up to about 99.5% by weight, especially up to about 30% by weight, up to about 20% by weight or up to about 10% by weight. Within the scope of a preferred embodiment of the present invention, the lower limit for the described plasticisers as constituent of the stabiliser compositions according to the invention is about 0.1% by weight or more, for example about 0.5% by weight, 1% by weight, 2% by weight or 5% by weight.

Within the scope of a further embodiment of the present invention, the stabiliser compositions according to the invention can comprise antioxidants, UV absorbers or light stabilisers. Suitable antioxidants are described, for example, on pages 33 to 35 of EP-A 1 046 668. Antioxidants preferred in the context of the present invention are the products of the Irganox® range (manufacturer: Ciba Specialty Chemicals), for example Irganox® 1010 or 1076 or products of Lowinox® range from Great Lakes. Suitable UV absorbers and light stabilisers are mentioned therein on pages 35 and 36. Reference is expressly made to both disclosures, the disclosures being regarded as part of this text.

Also suitable as additives in the stabiliser compositions according to the invention are hydrotalcites, hydrocalumites, zeolites and alkali alumocarbonates. Suitable hydrotalcites, hydrocalumites, zeolites and alkali alumocarbonates are described, for example, on pages 27 to 29 of EP-A 1 046 668, on pages 3, 5 and 7 of EP-A 256 872, on pages 2 and 3 of DE-C 41 06 411 and on pages 2 and 3 of DE-C 41 06 404 or in DE-C 198 60 798. Reference is expressly made to those specifications, and their disclosure is regarded as being part of the disclosure of this text. The hydrotalcites, hydrocalumites, zeolites and alkali alumocarbonates suitable as additives can be present in a stabiliser composition according to the invention in an amount of up to about 50% by weight, for example from 0 up to about 30% by weight.

Pigments are also suitable as constituents of the stabiliser compositions according to the invention. Examples of suitable inorganic pigments are titanium dioxide, carbon black, Fe₂O₃, Sb₂O₃, (Ba, Sb)O₂, Cr₂O₃, spinels, such as cobalt blue and cobalt green, Cd (S, Se) or ultramarine blue. Suitable organic pigments are, for example, azo pigments, phthalocyanine pigments, quinacridone pigments, perylene pigments, diketopyrrolopyrrole pigments and anthraquinone pigments.

A stabiliser composition according to the invention can also comprise fillers, such as those described on pages 393 to 449 of “Handbook of PVC Formulating”, E. J. Wickson, John Wiley & Sons, Inc., 1993, or reinforcing agents, such as those described on pages 549 to 615 of “Taschenbuch der Kunststoffadditive”, R. Gächter/H. Müller, Carl Hanser Verlag, 1990. Especially suitable fillers or reinforcing agents are, for example, calcium carbonate (chalk), dolomite, wollastonite, magnesium oxide, magnesium hydroxide, silicates, glass fibres, talc, kaolin, chalk, carbon black or graphite, wood flour or other renewable raw materials. Within the scope of a preferred embodiment of the present invention, a stabiliser composition according to the invention comprises chalk.

A stabiliser composition according to the invention can also comprise impact strength modifiers and processing aids, gelling agents, antistatics, biocides, metal deactivators, optical brighteners, flame retardants and also antifogging compounds. Suitable compounds of those classes of compound are described, for example, in “Kunststoff Additive”, R. Kessler/H. Müller, Carl Hanser Verlag, 3rd edition, 1989 and also in “Handbook of PVC Formulating”, E. J. Wilson, J. Wiley & Sons, 1993.

Within the scope of a further embodiment of the present invention, a stabiliser composition according to the invention comprises at least one basic calcium salt. Suitable basic calcium salts are, for example, calcium oxide, calcium carbonate and calcium hydroxide. The basic calcium salts can optionally be surface-modified

In a very especially preferred embodiment, the stabiliser composition according to the invention comprises at least two of the above-mentioned additives, a mixture that is preferred in turn comprising, for example, at least two, but preferably 3, 4, 5 or more, of the constituents mentioned below: Baerorapid 30 FD (processing aid, acrylate-based), zeolite, Ceasit SW (calcium stearate), Ca(OH)₂, paraffin wax, PE wax, oxidised PE wax.

The present invention relates also to a process for the preparation of a stabiliser composition for halogen-containing polymers in which a salt of a halogen-containing oxy acid and at least one blowing agent are so mixed with one another that the composition resulting from the mixing comprises at least 0.1% by weight, based on the total weight of the composition, of the at least one blowing agent.

The stabiliser compositions can be in liquid form or in solid form.

The preparation of a solid stabiliser composition in accordance with the present invention is effected in principle by any method known to the person skilled in the art for mixing together different solid or solid and liquid substances, for example by simply mixing the at least one halogen-containing salt of an oxy acid with blowing agent and optionally further additives.

In accordance with a further preferred embodiment of the process according to the invention, first an aqueous solution of a salt of a halogen-containing oxy acid, more preferably a salt of the general formula M(ClO₄)ₖ wherein M is inter alia preferably Li, Na, K, Mg, Ca, Sr, Zn, Al, La, Ce or ammonium, or a mixture of two or more such salts, is reacted with an inorganic or organic acid anhydride or an inorganic base anhydride.

The present invention therefore relates also to a process for the preparation of a stabiliser composition for halogen-containing polymers, which is characterised in that an aqueous solution of a halogen-containing oxy acid or an aqueous solution of a mixture of two or more halogen-containing oxy acids is reacted with an inorganic or organic acid anhydride or an inorganic base anhydride or a mixture of two or more thereof to form a reaction product and the reaction product is used to stabilise a polymer composition that comprises at least one blowing agent or is mixed with at least one blowing agent, so that the blowing agent content is at least about 0.1% by weight.

For that purpose, within the scope of a first embodiment of the present invention an inorganic or organic acid anhydride or an inorganic base anhydride or a mixture of two or more inorganic or organic acid anhydrides or a mixture of two or more inorganic base anhydrides is prepared in powder form. The process according to the invention can, however, equally be carried out with a mixture of one or more inorganic acid anhydrides and one or more inorganic base anhydrides.

The powders used in the context of the process according to the invention preferably have an average particle size of less than about 100 μm, preferably less than about 60 μm and especially less than about 40 μm.

For carrying out the process according to the invention, one of the above-mentioned anhydride compounds or one of the above-mentioned mixtures is reacted with an aqueous solution of a salt of a halogen-containing oxy acid or a mixture of two or more such salts. The reaction is carried out in the context of the process according to the invention by reacting the anhydride with the water supplied by the aqueous solution of the halogen-containing salt of the oxy acid or the mixture of two or more such acids to form the acid or base in question. The corresponding details of such a reaction can be found in the German patent application having the file reference DE 101 24 734.6. Reference is expressly made to that specification and the disclosure of the specification is regarded as part of the disclosure of this text.

A stabiliser composition according to the invention, in addition to comprising the essential compounds already described above, the salt of a halogen-containing oxy acid and the blowing agent, may also comprise one or more further additives in an amount mentioned above.

It has been found in the context of the present invention that the onium salts of perchlorates are suitable for stabilising foams of halogen-containing organic polymers. The present invention therefore also describes a polymer composition, at least comprising a halogen-containing, organic polymer, an onium salt of a perchlorate and at least 0.1% by weight of a blowing agent. The amounts of onium salts to be used correspond to the amounts described elsewhere in the text for the stabiliser compositions according to the invention.

Examples of such halogen-containing organic polymers are polymers of vinyl chloride, vinyl resins containing vinyl chloride units in the polymer backbone, copolymers of vinyl chloride and vinyl esters of aliphatic acids, especially vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or anhydrides thereof, for example copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and other compounds such as acrolein, crotonaldehyde, vinyl methyl ketone, vinyl methyl ether, vinyl isobutyl ether and the like, polymers and copolymers of vinylidene chloride with vinyl chloride and other polymerisable compounds, such as those already mentioned above, polymers of vinyl chloroacetate and dichlorodivinyl ether, chlorinated polymers of vinyl acetate, chlorinated polymeric esters of acrylic acid and α-substituted acrylic acids, chlorinated polystyrenes, for example polydichlorostyrene, chlorinated polymers of ethylene, polymers and post-chlorinated polymers of chlorobutadiene and copolymers thereof with vinyl chloride and also mixtures of two or more of the mentioned polymers or polymer mixtures that contain one or more of the above-mentioned polymers. Within the scope of a preferred embodiment of the present invention, the stabiliser compositions according to the invention are used for the production of moulded articles of PVC-U, such as window profiles, industrial profiles, tubes and plates.

Also suitable for stabilisation with the stabiliser compositions according to the invention are the graft polymers of PVC with EVA, ABS or MBS. Preferred substrates for such graft copolymers are also the afore-mentioned homo- and co-polymers, especially mixtures of vinyl chloride homopolymers with other thermoplastic or elastomeric polymers, especially blends with ABS, MBS, NBR, SAN, EVA, CPE; MBAS, PM (polyalkyl acrylate), PAMA (polyalkyl methacrylate), EPDM, polyamides or polylactones.

Likewise suitable for stabilisation with the stabiliser compositions according to the invention are mixtures of halogenated and non-halogenated polymers, for example mixtures of the above-mentioned non-halogenated polymers with PVC, especially mixtures of polyurethanes and PVC.

Furthermore, it is also possible for recyclates of chlorine-containing polymers to be stabilised with the stabiliser compositions according to the invention, in principle any recyclates of the above-mentioned halogenated polymers being suitable for this purpose. PVC recyclate, for example, is suitable in the context of the present invention.

The present invention therefore relates also to a polymer composition, at least comprising a halogenated polymer and a stabiliser composition according to the invention or a stabiliser composition prepared by a process according to the invention.

Within the scope of a preferred embodiment of the present invention, a polymer composition according to the invention comprises the stabiliser composition according to the invention in an amount of from 0.1 to 20 phr, especially from approximately 0.5 to approximately 15 phr or from approximately 1 to approximately 12 phr. The unit phr represents “per hundred resin” and thus relates to parts by weight per 100 parts by weight of polymer.

The present invention therefore relates also to a polymer composition, as described above, which is characterised in that it comprises the stabiliser composition in an amount of from 0.1 to 20% by weight.

A polymer composition according to the invention preferably comprises as halogenated polymer as least a proportion of PVC, the PVC content being especially at least about 20% by weight, preferably at least about 50% by weight, for example at least about 80% by weight or at least about 90% by weight.

The present invention relates also to a method of stabilising foams of halogen-containing polymers in which a halogen-containing polymer or a mixture of two or more halogen-containing polymers or a mixture of one or more halogen-containing polymers and one or more halogen-free polymers is mixed with a blowing agent and a stabiliser composition comprising at least one salt of a halogen-containing oxy acid.

The mixing together of polymers, the blowing agent or blowing agent mixture and the remaining stabiliser composition comprising at least one salt of a halogen-containing oxy acid can in principle be effected at any time before or during the processing of the polymer. For example, the stabiliser composition can be mixed into the pulverulent or granular polymer prior to processing. It is equally possible, however, to add the stabiliser composition to the polymer or polymers in the softened or molten state, for example during processing in an extruder, in the form of an emulsion or dispersion, in the form of a pasty mixture, in the form of a dry mixture or in the form of a solution or melt.

A polymer composition according to the invention can be brought into a desired form in known manner. Suitable methods are, for example, the processes customarily used in the production of foamed materials and foamed core moulded articles.

A polymer composition according to the invention can be processed to form foamed moulded articles. The present invention therefore relates also to foamed moulded articles, at least comprising a stabiliser composition according to the invention or a polymer composition according to the invention.

The term “foamed moulded article” in the context of the present invention in principle includes any three-dimensional structures that can be produced from a foamed polymer composition according to the invention. In the context of the present invention the term “foamed moulded article” includes, for example, automobile components, for example automobile components such as are used in the interior of the automobile, in the engine space or on the outer surfaces, shaped sealing elements, tubes, structural profiles, sidings, plates or co-extrudates having a recycled core. Further examples of moulded articles that can be produced from a polymer composition according to the invention are synthetic leather, floor coverings, textile coatings, wall coverings, coil coatings and underseals for motor vehicles.

The present invention relates also to the use of a stabiliser composition according to the invention or a stabiliser composition prepared in accordance with the invention or an above-described polymer composition for the production of foamed polymeric moulded articles.

The invention is explained in greater detail below by Examples:

### EXAMPLES

### Example 1

### Preparation of the Perchlorate

7.14 g of an aqueous solution of 70% by weight sodium perchlorate in water were reacted with a mixture of 6.66 g of calcium oxide (particle size D₅₀: 14.5 μm) and 36.2 g of calcium hydroxide (particle size D₅₀: 6.5 μm) (combination 1). An electron microscopic examination of the mixture did not demonstrate any definite crystallites of sodium perchlorate. An X-ray diffractogram exhibited no reflection at 2 θ=25.14°, demonstrating the absence of crystalline sodium perchlorate having a crystallite size of more than 5 nm.

### Example 2

### Preparation of Polymer Compositions According to the Invention and Comparison Compositions Without Perchlorate or Without Blowing Agent

The mixtures listed in Table 1 were prepared from polyvinyl chloride (Solvic 258 RB), a mixture of Baerorapid 30 FD (processing aid, acrylate-based), zeolite, Ceasit SW (calcium stearate), Ca(OH)₂, paraffin wax, PE wax, oxidised PE wax and the perchlorate prepared according to Example 1, with the use in some cases of four different additional blowing agents:

| Raw material | 1 | 2 | 3 | 4 | 5 | 6 | 7 | 8 | 9 | 10 |
|---|---|---|---|---|---|---|---|---|---|---|
| Solvic¹ | 100 | 100 | 100 | 100 | 100 | 100 | 100 | 100 | 100 | 100 |
| Chalk | 10 | 10 | 10 | 10 | 10 | 10 | 10 | 10 | 10 | 10 |
| SKR² | 4.35 | 4.35 | 4.35 | 4.35 | 4.35 | 4.35 | 4.35 | 4.35 | 4.35 | 4.35 |
| Perchlorate³ | | | | 0.10 | 0.10 | 0.10 | | | 0.10 | 0.10 |
| ADCA⁴ | | 0.14 | | | 0.14 | | | 0.14 | | 0.14 |
| Blowing | | | 0.14 | | | 0.14 | | | | |
| agent | | | | | | | | | | |
| Zinc | 0.20 | 0.20 | 0.20 | 0.20 | 0.20 | 0.20 | | | | |
| BGAC⁵ | | | | | | | 0.20 | 0.20 | 0.20 | 0.20 |

¹= Polyvinyl chloride
²= Composition comprising the following:
1 part by weight Baerorapid 30 FD (processing aid, acrylate-based)
0.75 part by weight zeolite
0.6 part by weight Ceasit SW (calcium stearate)
0.2 part by weight Ca(OH)₂
0.7 part by weight paraffin wax
0.8 part by weight PE wax
0.3 part by weight oxidised PE wax
in each case based on 100 parts PVC (phr)
³= sodium perchlorate, supported on Ca(OH)2
⁴= azodicarbonamide
⁵= butylene glycol-bis(3-aminocrotonate)
Preparation is effected in all cases in a 10 litre heating-cooling mixer.

### Example 3

### Investigation of the Compositions of Example 2

The polymer compositions listed in Example 2 were investigated using a metal block thermostat (Liebisch). Three test pieces having a mass of (50±5) mg were produced per composition and investigated in respect of their thermal stability according to DIN VDE 0472 part 614 (HCL test) at a test temperature of (200±0.5)° C. Table 2 gives the resulting individual values for the stability times as well as the average values of the stability times of the three test pieces.

| | | | | Average |
|---|---|---|---|---|
| Specimen | Stability time | Stability time | Stability time | value |
| No: | 1 [min] | 2 [min] | 3 [min] | [min] |
| 1 | 13 | 13 | 13 | 13 |
| 2 | 9 | 9 | 9 | 9 |
| 3 | 11 | 11 | 11 | 11 |
| 4 | 15 | 15 | 15 | 15 |
| 5 | 11 | 12 | 3 | 12 |
| 6 | 12 | 13 | 13 | 13 |
| 7 | 13 | 13 | 13 | 113 |
| 8 | 9 | 10 | 10 | 10 |
| 9 | 18 | 18 | 18 | 18 |
| 10 | 16 | 16 | 17 | 16 |

### Example 4

### Preparation of Polymer Compositions According to the Invention and Comparison Compositions Without Perchlorate and/or Without Blowing Agent and/or Further Additives

The mixtures listed in Table 1 were prepared from polyvinyl chloride (Solvic 258 RB), a mixture of Baerorapid 30 FD (processing aid, acrylate-based), zeolite, Ceasit SW (calcium stearate), Ca(OH)₂, paraffin wax, PE wax, oxidised PE wax and the perchlorate prepared according to Example 1, with the use of two different additional blowing agents. In some cases they contain optional further additives zinc SW F and butylene glycol bis-3-aminocrotonate.

| Raw material | 1 | 2 | 3 | 4 | 5 | 6 | 7 | 8 | 9 | 10 |
|---|---|---|---|---|---|---|---|---|---|---|
| Solvic¹ | 100 | 100 | 100 | 100 | 100 | 100 | 100 | 100 | 100 | 100 |
| Chalk | 10 | 10 | 10 | 10 | 10 | 10 | 10 | 10 | 10 | 10 |
| SKR² | 4.35 | 4.35 | 4.35 | 4.35 | 4.35 | 4.35 | 4.35 | 4.35 | 4.35 | 4.35 |
| Perchlorate³ | | | | | | 0.10 | 0.10 | 0.10 | 0.10 | 0.10 |
| Azodicarbonamide* | | 0.14 | | | | | 0.14 | | | |
| Azodicarbonamide* | | | 0.14 | | | | | 0.14 | | |
| Blowing agent* | | | | 0.14 | | | | | 0.14 | |
| ADCA⁴ | | | | | 0.14 | | | | | 0.14 |

¹= polyvinyl chloride
²= composition comprising the following:
1 part by weight Baerorapid 30 FD (processing aid, acrylate-based)
0.75 part by weight zeolite
0.6 part by weight Ceasit SW (calcium stearate)
0.2 part by weight Ca(OH)₂
0.7 part by weight paraffin wax
0.8 part by weight PE wax
0.3 part by weight oxidised PE wax
in each case based on 100 parts PVC (phr)
³= sodium perchlorate, supported on Ca(OH)₂
⁴= azodicarbonamide
*= commercially available azodicarbonamide-containing blowing agent from various manufacturers
Preparation is effected in all cases in a 10 litre heating-cooling mixer.

### Example 5

### Investigation of the Compositions of Example 4

The polymer compositions listed in Example 4 were investigated using a metal block thermostat (Liebisch). Three test pieces having a mass of (50±5) mg were produced per composition and investigated in respect of their thermal stability according to DIN VDE 0472 part 614 (HCL test) at a test temperature of (200±0.5)° C.

Table 4 below gives the resulting individual values for the stability times as well as the average values of the stability times of the three test pieces.

| | | | | Average |
|---|---|---|---|---|
| Specimen | Stability time | Stability time | Stability time | value |
| No.: | 1 [min] | 2 [min] | 3 [min] | [min] |
| 1 | 12 | 12 | 14 | 13 |
| 2 | 7 | 7 | 8 | 7 |
| 3 | 9 | 9 | 10 | 9 |
| 4 | 9 | 9 | 10 | 9 |
| 5 | 7 | 7 | 7 | 7 |
| 6 | 18 | 18 | 18 | 18 |
| 7 | 14 | 14 | 14 | 14 |
| 8 | 15 | 15 | 15 | 15 |
| 9 | 14 | 14 | 15 | 14 |
| 10 | 12 | 13 | 14 | 13 |

That which is claimed:

1. A stabiliser composition for foams of halogen-containing polymers comprising:
from 0.01 to about 50% by weight of at least one salt of a halogen-containing oxyacid, and
from 0.5 to about 50% by weight of at least one blowing agent,
both based on the total weight of the stabiliser composition.

2. The stabiliser composition according to claim 1, wherein the blowing agent comprises azodicarbonamide.

3. The stabiliser composition according to claim 1, wherein the at least one salt of a halogen-containing oxyacid comprises less than 10% crystallites having a crystallite size greater than 3 μm.

4. The stabiliser composition according to claim 1, wherein the stabiliser composition further comprises at least one compound based on an α,β-unsaturated β-aminocarboxylic acid.

5. The stabiliser composition according to claim 1, wherein the stabiliser composition is substantially free of heavy-metal-containing stabilisers.

6. The stabiliser composition according to claim 1, wherein the at least one salt of a halogen-containing oxyacid comprises an inorganic salt of perchloric acid, an organic salt of perchloric acid, or a combination thereof.

7. The stabiliser composition according to claim 6, wherein the organic salt of of perchloric acid is selected from the group consisting of phosphonium perchlorate, sulfonium perchlorate, ammonium perchlorate, and combinations thereof.

8. A process for the preparation of a stabiliser composition for halogen-containing polymers comprising:
mixing at least one salt of a halogen-containing oxyacid with at least one blowing agent to produce a composition that comprises from 0.01 to about 50% by weight of at least one salt of a halogen-containing oxyacid and from 0.5 to about 50% by weight of at least one blowing agent, both based on the total weight of the stabiliser composition.

9. A polymer composition comprising:
at least one halogen-containing polymer; and
a stabiliser composition comprising from 0.01 to about 50% by weight of at least one salt of a halogen-containing oxyacid and from 0.5 to about 50% by weight of at least one blowing agent, both based on the total weight of the stabiliser composition.

10. The polymer composition according to claim 9, wherein the stabiliser composition is present in the polymer composition in an amount from 0.1 to 20% by weight, based on the total weight of the polymer composition.

11. The polymer composition according to claim 9, wherein the at least one halogen-containing polymer includes halogen-containing polymers selected from the group consisting of a halogen-containing polymer, a mixture of two or more halogen-containing polymers, and a mixture of one or more halogen-containing polymers and one or more halogen-free polymers.

12. The polymer composition according to claim 9, wherein the polymer composition is in the form of a moulded article.

13. A method of stabilising a halogen-containing polymer comprising mixing at least one halogen-containing polymer with a stabiliser composition comprising from 0.01 to about 50% by weight of at least one salt of a halogen-containing oxyacid and from 0.5 to about 50% by weight of at least one blowing agent, both based on the total weight of the stabiliser composition.

14. The method according to claim 13, wherein less than 10% of salt crystallites in the at least one salt of a halogen-containing oxyacid have a crystallite size greater than 3 μm.

15. A method of stabilising a polymer composition comprising mixing
a stabilising composition comprising at least one salt of a halogen-containing oxyacid with
a polymer composition comprising at least one halogen-containing polymer and at least 0.1% by weight of a blowing agent, based on the total weight of the polymer composition;
wherein the stabilising composition comprises less than 10% of salt crystallites in the at least one salt of a halogen-containing oxyacid having a crystallite size greater than 3 μm.
